(19) United States
(12) Patent Application Publication
(10) Pub. No.: US 2006/0181058 A1
(43) Pub. Date: Aug. 17, 2006

(54) Hitch-a-bike

(76) Inventors: Carl Everett Smith, Interlachen, FL (US); Thomas Raymond Stratton, Daytona Beach, FL (US)

Correspondence Address: TOM STRATTON, 305 COUNTRY CIRCLE DRIVE EAST, PORT ORANGE, FL, 32128, US

(21) Appl. No.: 11/311,853

(22) Filed: Dec. 19, 2005

Related U.S. Application Data
(60) Provisional application No. 60/639,371, filed on Dec. 27, 2004.

(51) Int. Cl. B62D 53/02

(52) U.S. Cl. 280/492

(57) ABSTRACT

The invention is a motorcycle transporting device that is designed to be connected to a vehicle through a standard trailer hitch receiver and consists of one main component and several sub-components, specifically, a wheel support member, referred to as wheel cup, that is rigidly affixed to a hinged shaft assembly that has a lifting mechanism allowing the wheel cup to be raised and lowered and when in the raised position would carry a motorcycle by its front wheel.

### CROSS-REFERENCE TO RELATED APPLICATIONS

This application claims the benefit Provisional Patent Application Ser. No. 60/639,371 filed Dec. 27, 2004.

### APPLICATION (FIELD OF INVENTION)

This invention is a motorcycle (or like vehicle) towing device. It is designed to be inserted into a standard two inch trailer hitch receiver commonly used on many motor vehicles and tow a motorcycle (or like vehicle) in an upright forward facing direction by its front wheel, traveling on its rear wheel.

### BRIEF DESCRIPTION OF THE DRAWINGS

FIG. 1 is a side view of invention in a raised or towing position

FIG. 2 is a perspective view of invention that best illustrates the specially designed “C” shaped wheel cup, wheel lock pin, the shaft extending outward for securing with tie down straps and safety pin assembly

FIG. 3. is a side view of invention in an open or loading position.

### DESCRIPTION OF PREFERRED EMBODIMENT

The description below of the preferred embodiment of the invention is only one potential embodiment and should not be considered as limiting to the invention.

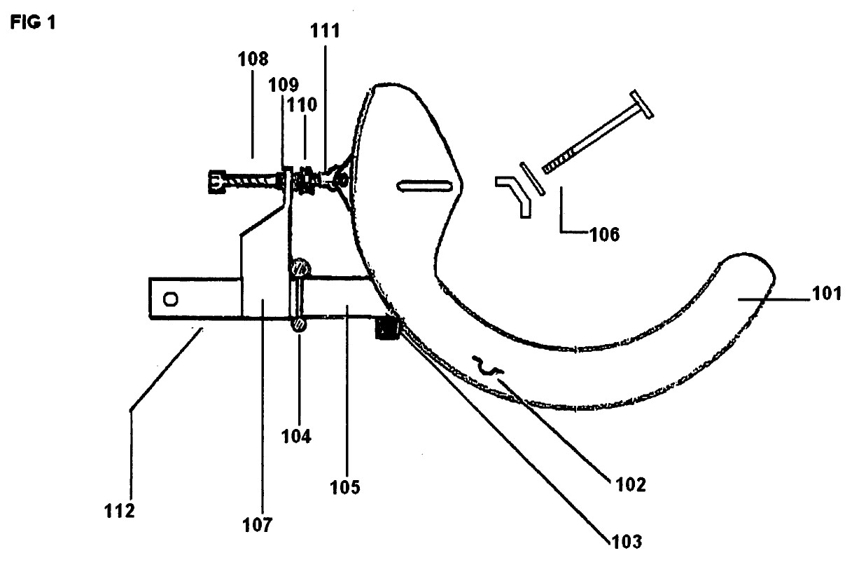

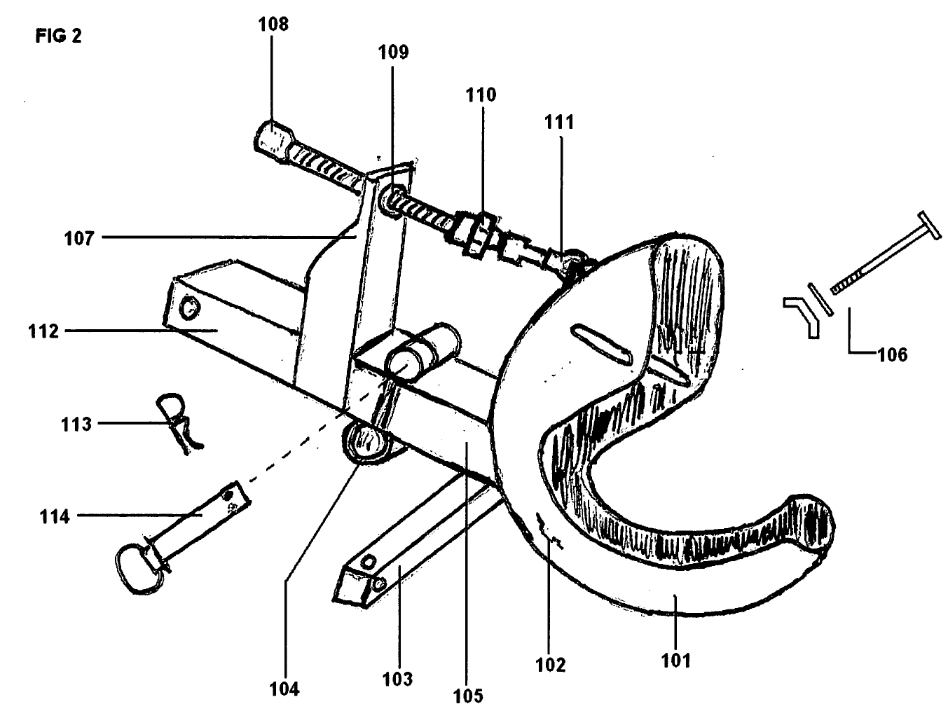

FIGS. 1 and 2 illustrate the various mechanical parts of the invention. The specially designed wheel cup (101) made from a formed steel that encompasses the front wheel of a motorcycle is welded to a two inch square steel member (105) which is connected to a secondary two inch square steel member of the same type (112) using a typical barrel type hinge (104) at the lower portion of the shafts. A smaller square steel shaft of the same type (103) is welded to the lower portion of wheel cup (101) and rear shaft (105) and extends outward equally to both sides with holes in the ends for securing motorcycle with ratcheting type or similar straps. The strap loops (102) are a raised steel ring welded to the wheel cup (101) for a secondary securing method. The lock pin set (106) is essentially a steel bolt that runs through both lock pin slots and the wheel of the motorcycle with a flat washer and wing type nut to secure the motorcycle wheel into the wheel cup. Extending upward in a perpendicular direction from the front shaft (112) is a steel rod plate (107) Traveling parallel to the front shaft (112) is a lift rod (108) which is a hardened steel threaded rod that screws through a rod coupler (109) that is welded into the rod plate (107). The drive end of the lift rod is fitted for a standard half inch drive ratchet. As the lift rod is turned and travels through the rod plate the universal-type joint (110) at the opposite end, allows the secondary rod connected to the hiem joint assembly (111) to account for the change in angle of degree as the wheel cup is raised and lowered. When the wheel cup is in its fully raised position the safety pin (114) is inserted into the safety pin slot as shown in FIG. 2 and cotter pin (113) is inserted into the hole in end of safety pin.

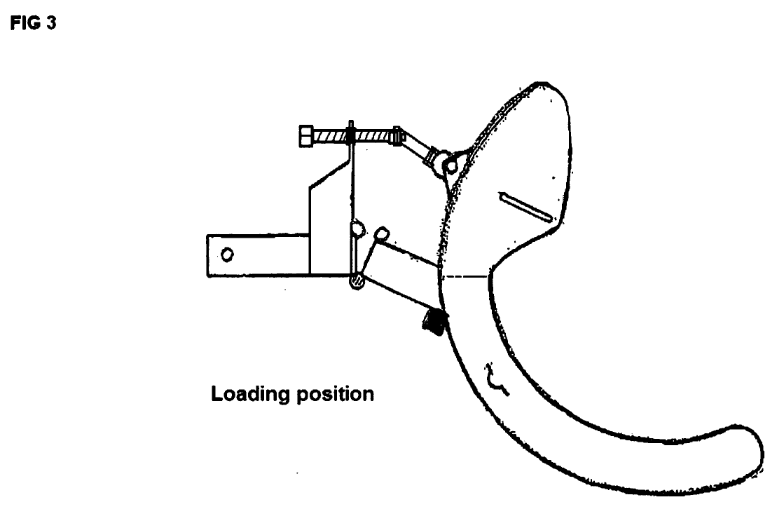

To use the Hitch-a-Bike, you first insert the front shaft (112) into a standard two inch receiver on the rear of a motor vehicle while the Hitch-a-Bike is in its closed or up position as shown in FIGS. 1 &2. Secure Hitch-a-Bike to the receiver with the pin supplied by the hitch manufacturer. The unit is then lowered by turning lift rod (108) to the loading position as shown in FIG. 3. The motorcycle front wheel is rolled into the wheel cup and secured to the tie down rod (103) using typical ratcheting type straps (not shown). Once secured, the lift rod (108) is turned to raise the front wheel of the motor cycle. When fully raised as shown in FIGS. 1&2, insert safety pin (114) & cotter pin (113) into safety pin slot as shown in FIG. 2. If motorcycle wheel is an open design lock pin assembly (106) may be used. If the wheel is a solid and lock pin cannot be used strap loops (102) may be utilized.

### SUMMARY

Overall this towing device is made of up of very few moving parts which allows for a simplistic one person operation. The specially designed wheel cup is one piece and offers better wheel to surface contact than other methods and its unique shape allows for more side to side stability of the motorcycle tire.

1. A motorcycle towing device for towing with the wheels in tandem, said device is attached to the rear of a motor vehicle and consists of,
(a) an upright specially designed support member referred to as the “wheel cup” that is designed to encompass a portion of the front wheel of said motorcycle by wrapping around a portion of the circumference of the wheel and traveling around the width of the wheel and tire in a “c” shaped manner, having an elongated area in the upper portion that is to extend inward and having a slot opening on both the left and right sides parallel to the line of the vehicle attachment members.
(b) a threaded metal bolt that is inserted into the slot openings in the elongated area of the upper portion of the wheel cup that travels from one side of the wheel cup through the motor cycle wheel to the opposite side secured with a large wing type nut.
(c) two square attachment members, one rigidly connected to the wheel cup, with a hinge member that allows the two separate sections to pivot the wheel cup in a vertical up and down fashion while the opposite member stays securely fastened into a standard trailer hitch receiver with the motorcycle wheel being in a central parallel line to the attachment members.
(d) a vertical lift means that travels horizontally to the square attachment members, and a portion of, screws through a collar that is in a supporting member that is perpendicular to the fixed square attachment member and the opposing end is fitted with a universal type joint and connection to the wheel cup.
(e) one square support member mounted perpendicularly to the line of the square attachment members, in front of the wheel cup extending outward an equal distance to each side.
